(19) United States
(12) Patent Application Publication
(10) Pub. No.: US 2005/0047587 A1
(43) Pub. Date: Mar. 3, 2005

(54) Multifunction telephone

(76) Inventor: Floyd C. Green III, Woodland Hills, CA (US)

Correspondence Address: LITMAN LAW OFFICES, LTD., P.O. BOX 15035 CRYSTAL CITY STATION, ARLINGTON, VA, 22215, US

(21) Appl. No.: 10/649,948

(22) Filed: Aug. 28, 2003

(51) Int. Cl. H04M 1/00; H04M 9/00; H04M 3/00

(52) U.S. Cl. 379/387.01; 455/419

(57) ABSTRACT

The multifunction telephone is a telephone having a plurality of integrated audio modules, which may include an MP3 player, a AM/FM/Satellite radio receiver, a cassette player, a CD player, a radiotelephone or an audio source based upon any known technology. The audio generated by the audio module may be played through the telephone speaker for listening solely by the user, or may be injected into the transmit path of the telephone so that a telephonically connected party may hear the played audio. A mute switch controls the selection of one of a predetermined set of muting options.

### BACKGROUND OF THE INVENTION

1. Field of the Invention

The present invention relates to telephones, and particularly to a telephone having the capability to inject audio from an integrated radio, cassette player, CD or other audio source into the speaker, as well as into the telephone's transmit path to a connected party.

2. Description of the Related Art

With the continuous advances in technology, and in particular, the further miniaturization of microelectronics, multipurpose hand-held electronic devices, including cell phones, PDA's, cameras, and audio features are disclosed, if not yet available commercially. However, the specifics of implementation have been the subject of various patent disclosures.

U.S. Pat. Publication No. 2002/0082007, published in Jun. 2002, discloses a telephone device in which the caller selects stored music to be played in the background of the conversation. No radio or muting capability is disclosed.

A cellular telephone that includes an AM/FM receiver is disclosed in U.S. Pat. No. 6,510,325, issued to Mack, II et al. in January 2003. The subsystems in the '325 patent are prioritized such that one system is automatically interrupted based on higher priority activity, the radio function being the lowest priority. However, the functions are mutually exclusive and audio from the radio cannot be heard while the user is engaged in a cell phone conversation.

U.S. Pat. No. 6,519,475, issued to Kim in February of 2003, discloses an earphone-microphone combination having a switching device for changing the operational mode of the radio module between telephone mode and radio mode according to a first and second mode selection switch. Similarly, the two modes are mutually exclusive of each other.

A one-page reference entitled “Radio Telephone” was available on May 21, 2003 on the Internet at www.halfbakery.com/idea/Radio_{—}20telephone/addlink, and disclosed a cell phone enhancement to an automobile's audio system. In this reference, the radio would turn off or the volume would diminish when the cell phone rang. Although an interesting accessory for an automobile, the device does not integrate the radio into the cell phone, nor does the functionality exist outside the automobile.

None of the above inventions and patents, taken either singly or in combination, is seen to describe the instant invention as claimed. Thus a multifunction telephone solving the aforementioned problems is desired.

### SUMMARY OF THE INVENTION

The multifunction telephone is a telephone having an integrated audio source, which may include an MP3 player, an AM/FM radio receiver, a cassette player, a CD player, or any audio source which may be incorporated into the body or handset of a cable connected or cellular telephone. The generated audio may be heard not only by the user of the telephone through the telephone speaker, but may be heard by the telephonically connected distant party by electronically injecting the audio signal directly into the transmit path of the telephone circuitry.

The telephone includes an audio source selection capability which selects a particular audio source generated by a number of different audio modules, a volume control capability, and a switch that selectively mutes the audio generated by the audio source in either or both directions of communication. The audio source modules include, but are not limited to, an AM module, an FM module, a satellite radio module, an MP3 player, a cassette player, a CD-ROM, as well as a radiotelephone.

The multifunction telephone may be implemented in a cellular telephone, a cordless telephone having a base module, or a telephone having a handset electrically and physically connected to the base of the telephone. The antenna of the base station, or the antenna of the cellular telephone, functions not only to communicate with the handset or the cellular provider, but also operates to receive the wireless signal of a radio station corresponding to the selected audio module.

Accordingly, it is a principal object of the invention to provide a multifunction telephone with the capability to play music or audio from an integrated audio player through the telephone speaker.

It is another object of the invention to inject audio from an integrated audio player into the transmit path of a conversation held by the user and a telephonically connected party.

It is a further object of the invention to be able to control the volume level of the injected audio.

Still another object of the invention is to provide a muting capability that selectively mutes the volume of the injected audio in all possible combinations of the transmit and receive circuits.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a multifunction telephone having a cordless handset and a base according to the present invention.

FIG. 2 is a representative block diagram of the audio source within the present invention according to FIG. 1 illustrating different sources that may be incorporated in the multifunction telephone.

FIG. 3 is a representative block diagram of a multifunction telephone according to the multifunction telephone of FIG. 1.

FIG. 4 is a perspective view of a cellular telephone implementation of the multifunction telephone according to the present invention.

FIG. 5 is a representative block diagram of the cell phone embodiment of the multifunction telephone according to FIG. 4.

Similar reference characters denote corresponding features consistently throughout the attached drawings.

### DETAILED DESCRIPTION OF THE PREFERRED EMBODIMENTS

The present invention is a multifunction telephone capable of injecting internally generated or wirelessly received audio into either the telephone speaker or into the transmit path of the wire line or cellular telephone.

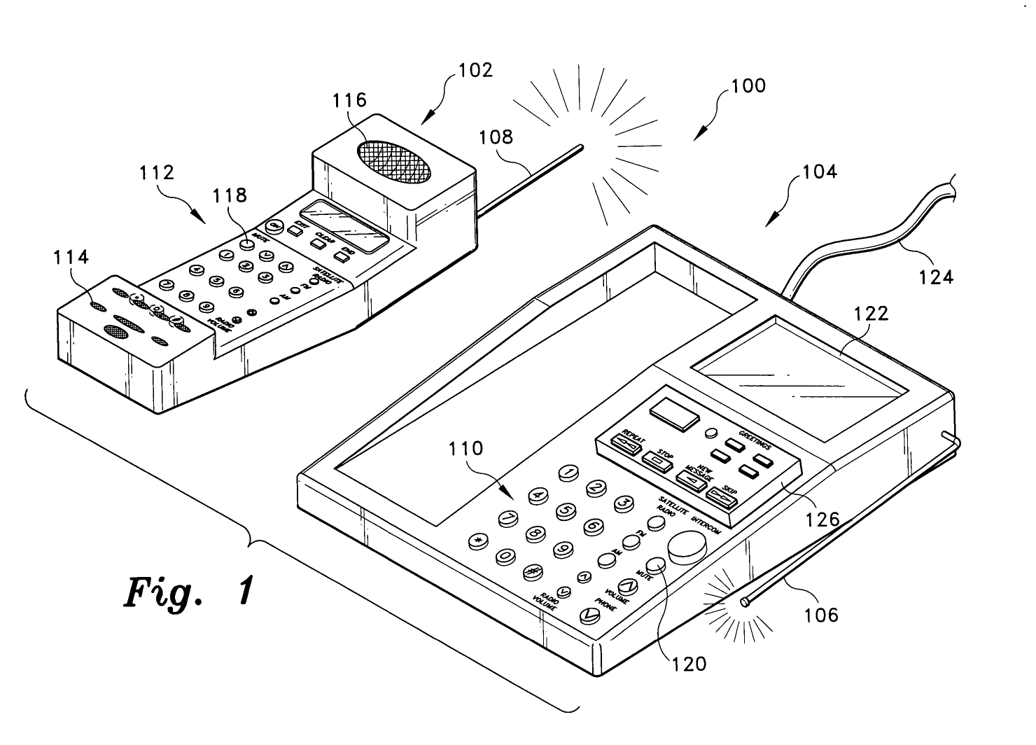

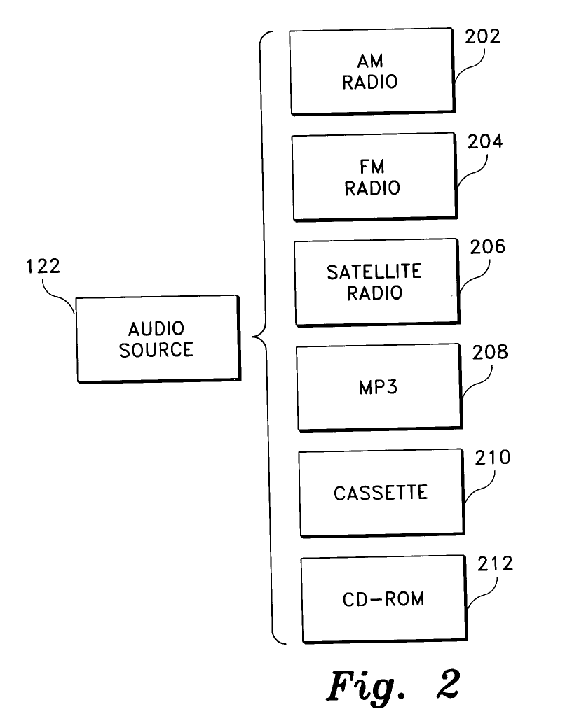

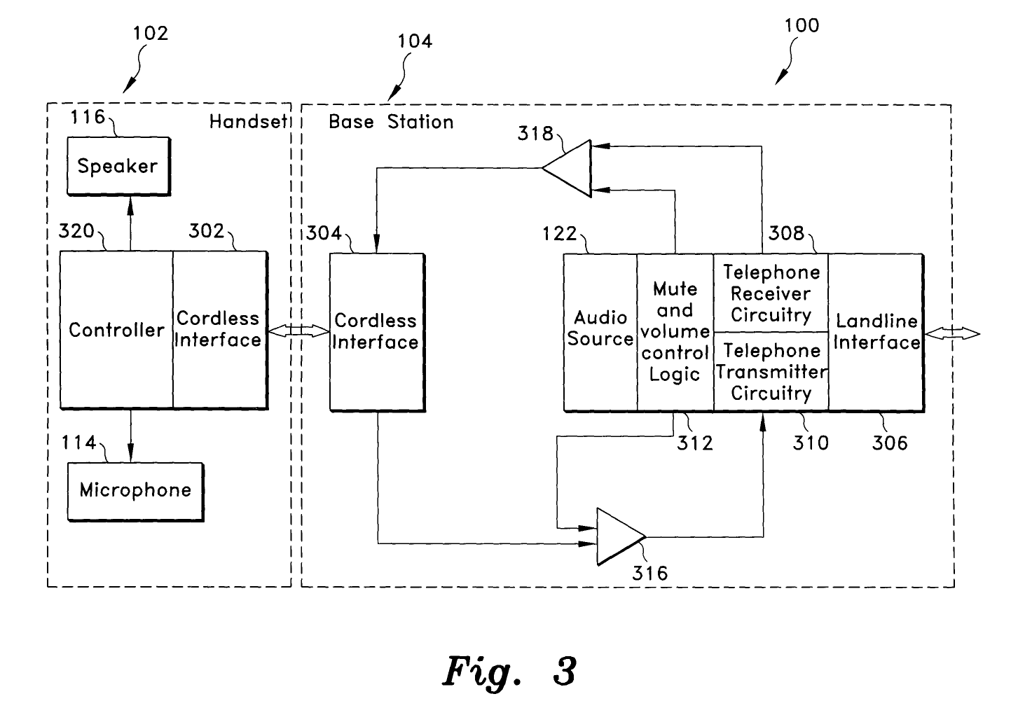

FIGS. 1 illustrates a multifunction telephone embodied in a telephone device 100 having a base station 104, a cordless handset 102, an audio module 122, an answering machine module 126, and a cable 124 for connecting the telephone 100 to a telephone network. As shown in FIG. 2, the audio module 122 may include multiple modules that allow the user to listen to one of several sources of audio entertainment. The multifunction telephone is designed to generate audio through the speaker not only when the telephone is inactive, but also when the user is engaged in a conversation with a distant party. As shown in FIG. 2, these modules may include an AM radio receiver 202, an FM radio receiver 204, a satellite radio receiver 206, an MP3 player 208, a tape cassette player 210, and a CD ROM player 212. Although FIG. 3 illustrates a selection of possible audio sources, the present invention 100 does not limit itself to these technologies, and may include a module receiving wireless transmission from any wireless source, including a radiotelephone as well as modules based upon new technologies for reproducing stored audio signals.

The base station antenna 106 not only extends the range within which the base 104 communicates with the handset 102, but in addition, receives radio signals from a radio station transmitter. Alternatively, a separate antenna (not shown) may be incorporated in the base station 104, one antenna for communicating with handset 102, and a separate antenna for receiving signals from a source of radio transmissions.

The handset 102 has an antenna 108 extending therefrom, and extends the distance within which the cordless handset may electronically communicate with the base station 104. The handset 102 further includes a speaker 116, a microphone 114, and control keypad and display unit 112 for operating the telephone portion of the device 100, as well as for selecting and regulating the audio generated by the audio module 122. The audio controls include audio selection buttons, volume control buttons and a mute switch 118.

As shown in FIG. 1, the controls on the handset 102 may be duplicated by placing controls 110 on the base station 104; however, placement of these controls are subject to the specific embodiment of the multifunction telephone.

Common to all embodiments is a mute switch 118, 120 disposed on the handset 102, the base 104, or in both locations, which functions to control the injection of audio into the telephone speaker 116, as well as into the transmit path of the telephone 100, thereby enabling a connected party to hear the audio generated by the audio module 122 in the background of the conversation.

As described in Table 1, the mute switch 118, 120 controls four possible combinations of muting the audio generated by audio module 122, whereby audio from the audio module 122 is reproduced by the internal speaker 116 or transmitted to the distant party, under full control of the user. Many of the functions of a modern electronic telephone are controlled by a microprocessor, and the actual program code written to index through the different muting choices, displaying the selection based upon the number of depressions of the mute switch, is dependent upon specific devices used and is well known to those skilled in the art.

TABLE 1
Mute Switch Combinations

| | Transmit | Transmit |
|---|---|---|
| | Path Enabled | Path Muted |
| Telephone | Position 1 | Position 3 |
| Speaker | | |
| Enabled | | |
| Telephone | Position 2 | Position 4 |
| Speaker | | |
| Muted | | |

As shown in the representative block diagram of FIG. 3, the multifunction device 100 is divided into a handset 102 and a base station 104. As previously disclosed, the handset 102 comprises a speaker 116 and a microphone 114 in electrical communication with logic controller 320 that includes the aforementioned telephone control and display section 112, which in turn, communicates with cordless interface 302.

The present invention 100 is comprised of standard telephony components known to those skilled in the art and includes base station 104, which incorporates a standard cordless interface 304, a landline interface 306 for interfacing to the public or private telephone network, telephone receiver circuitry 308 and telephone transmitter circuitry 310. In addition to these standard modules, the multifunction telephone 100 includes an audio source module 122, which may include any or all of the modules shown previously listed. Interconnecting the audio source module 122, the receiver circuitry 308 and the transmitter circuitry 310 is a mute and volume control module 312. Although the previously described mute capability may have control buttons in both the handset 102 and the base station 104, the actual switching of audio sources is best implemented in a single location. As shown in FIG. 3, the mute and volume control logic is located in the base station 104, the mute switch 118 in the handset merely controlling the audio source from its remote position. Amplifiers 316, 318, under control of the mute and volume control logic 312 individually control the injection of audio into the speaker 116 and the transmit path.

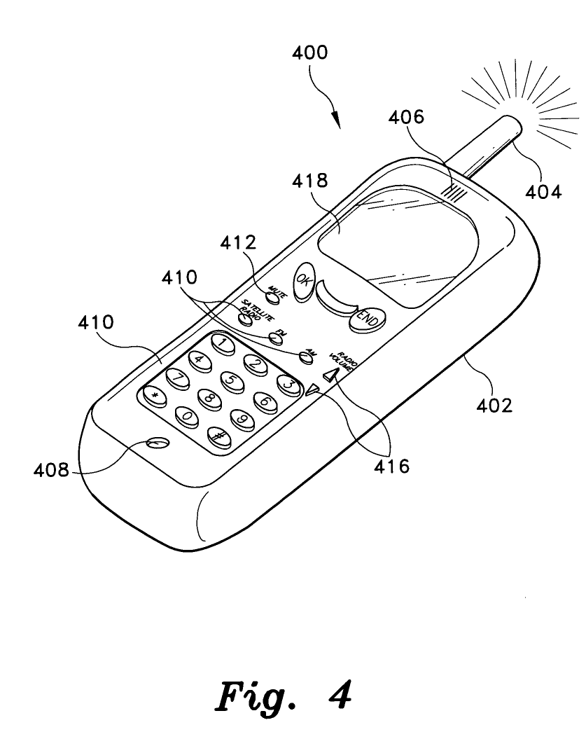

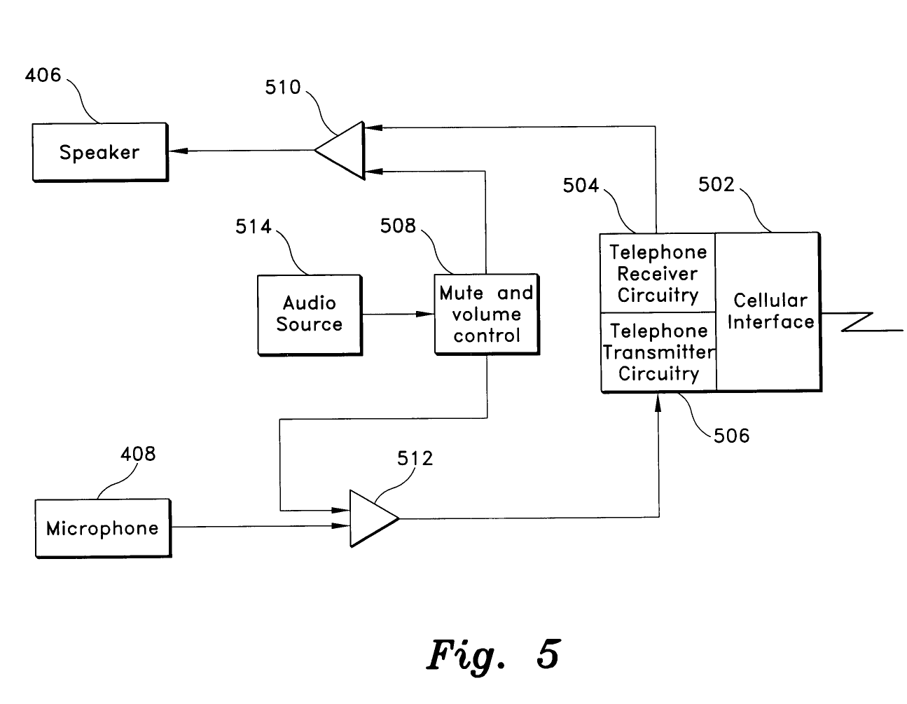

As previously mentioned, the multifunction telephone may be implemented in a cellular telephone, generally designated as 400 in FIGS. 4 and 5, and may incorporate any or all of the audio modules previously disclosed. The cellular telephone 400 is of unitary construction, and like most cellular telephones known to those in the art, includes a rigid plastic or metallic case 402, an antenna 404 for communicating with a cellular transmitter station, a speaker 406, a microphone 408, a numeric keypad 410 and a display unit 418. As shown in FIG. 4, a set of volume control buttons 416 may be placed on the cell phone specifically for regulating the volume of the audio injected into the background. Alternatively, the standard volume controls normally present on a cellular telephone may regulate both the volume of the received voice communication as well as the audio generated by the audio module 514. As previously disclosed, a mute switch 412, controlling the injection of audio into either the speaker 406 or the transmit path of the cell phone is disposed on the face of the cell phone 400.

Although FIGS. 4 and 5 may embody a multifunction cellular telephone having an integrated audio module comprising only radio capability, a cell phone embodiment of the present invention is not so limited. The cell phone may include not only those modules addressed in the landline embodiment 100, but may include all other technologies known in the field of cell phones and audio regeneration.

As shown in FIG. 5, a representative block diagram of a multifunction cellular telephone includes a cellular interface 502 for communicating with a cell site transmitter, telephone receiver circuitry 504 and telephone transmitter circuitry 506, the specific designs of which are known to those skilled in the art of cellular telephone. A selected output from at least one audio source 514 serves as an input signal to mute and volume control logic 508 which in turn controls the insertion of the signal into summing amplifiers 510, 512. The amplifiers 510, 512 combine the audio from the audio source with any ongoing conversation and outputs the combined audio to the speaker 406 or into the transmit path to be heard by the distant party.

Similar to the antenna design of the previous embodiment, the cell phone antenna 404 may serve the dual purpose of transmitting the telephonic signal to a cell site transmitter, as well as for receiving wireless radio from a transmitting site. Although this capability is well within the existing state of the art, an alternative embodiment of the present invention may have a separate antenna for receiving radio transmissions and for communicating with the cellular provider.

In operation, a user would not have to be in telephone communication with a second party to receive either radio broadcasts or other audio generated signals through the telephone speaker. Upon generating a call or upon notification of an incoming call, the audio from the internal audio source would cease momentarily until two-way communication was initiated, or until the call was aborted. When two-way voice communication is initiated, the default position of the mute switch is Position 1, whereby both parties may hear the audio from the audio module, the volume of which is controlled by a separate audio volume switch or by the standard handset volume controls present on most modern telephones. Depressing the mute switch indexes through the four possible combinations of muting, as described in Table 1. Although operation of the mute switch is as generally described above, the mute switch in the present embodiment is microprocessor controlled and as such, may be programmed to operate differently depending upon the manufacturer.

It is to be understood that the present invention is not limited to the embodiments described above, but encompasses any and all embodiments within the scope of the following claims.

1. A multifunction telephone, comprising:
transmit circuit means for transmitting telephony signals;
receive circuit means for receiving telephony signals;
a microphone electrically connect to the transmit circuit means;
a speaker electrically connected to the receive circuit means;
a keypad electrically connected to said transmit circuit means and said receive circuit means for entering control signals;
audio means for selecting and generating audio from a plurality of sources; and
muting means for controlling the injection of the audio means into the speaker and into the transmit circuit means;
whereby audio, generated by the audio means, may be heard by a user of the telephone and by a telephonically connected user.

2. The multifunction telephone according to claim 1, wherein said muting means comprises microprocessor means and circuit means for interpreting and implementing muting options selected by the user.

3. The multifunction telephone according to claim 1, wherein said audio means includes a radio receiver and means for tuning said radio receiver to a desired wireless transmitting station.

4. The multifunction telephone according to claim 3, wherein said radio receiver comprises at least one device selected from the group consisting of an AM radio, an FM radio, a satellite radio, and a radiotelephone.

5. The multifunction telephone according to claim 1, wherein said audio means comprises at least one device selected from the group consisting of an MP3 player, a CD player, and a cassette player.

6. The multifunction telephone according to claim 1, wherein said audio means includes a volume control.

7. The multifunction telephone according to claim 1, wherein the said transmit circuit means and said receive circuit means are configured for wireless cellular telephone communications.

8. The multifunction telephone according to claim 1, wherein the multifunction telephone further includes a base module housing said transmit circuit means and said receive circuit means, a handset removably attached to the base module, and a cable electrically connected to the base module and adapted for connection to a telephone network.

9. The multifunction telephone according to claim 8, wherein said handset is a cordless handset, electronically communicating with said base module over a wireless electronic medium.

10. The multifunction telephone according to claim 8, wherein said audio means is disposed in the base module.

11. A multifunction telephone, comprising:
a cellular telephone having transmit and receive circuit means for transmitting and receiving telephony signals, respectively;
audio means for selecting and generating audio from a plurality of sources;
a speaker electrically connected to the receive circuit means;
muting means for controlling the injection of audio generated by the audio means into the speaker and into the transmit circuit means; and
means for adjusting the source and volume of the audio;
whereby audio, generated by the audio means, may be selectively heard by the user of the telephone and a telephonically connected user.

12. The multifunction telephone according to claim 11, wherein said audio means comprises at least one device selected from the group consisting of an MP3 player, a CD player, a cassette player, and a radio receiver.
